(19) United States
(12) Patent Application Publication
(10) Pub. No.: US 2009/0272403 A1
(43) Pub. Date: Nov. 5, 2009

(54) CUTTER BLADE CLEANING METHOD AND CUTTER BLADE CLEANING DEVICE, AS WELL AS ADHESIVE TAPE JOINING APPARATUS INCLUDING THE SAME

(76) Inventors: Masayuki Yamamoto, Ibaraki-shi (JP); Yukitoshi Hase, Kameyama-shi (JP)

Correspondence Address: Cheng Law Group, PLLC, 1100 17th Street, N.W., Suite 503, Washington, DC, 20036, US

(21) Appl. No.: 12/426,958

(22) Filed: Apr. 20, 2009

(30) Foreign Application Priority Data
May 2, 2008 (JP) 2008-120567

(51) Int. Cl. B08B 1/00; B32B 38/00; B26D 7/08

(52) U.S. Cl. 134/6; 156/523; 83/168

(57) ABSTRACT

In a container that retains a wash liquid, a cutter blade having a cutting edge is inserted into a slit formed on a cleaning member impregnated with the wash liquid from an opening side of the slit and is moved horizontally by a predetermined amount with two side faces thereof being brought into contact with the slit. Then, the cutter blade is pulled out upward, so that adherents on the two side faces of the cutter blade are removed from the cuter blade.

### BACKGROUND OF THE INVENTION

(1) Field of the Invention

This invention relates to a cutter blade cleaning method and a cutter blade cleaning device each used for cleaning a cutter blade that cuts out a protective adhesive tape, which is joined to a surface of a substrate such as a semiconductor wafer, along a contour of the substrate, as well as an adhesive tape joining apparatus including the same.

(2) Description of the Related Art

Conventionally, a surface-protective adhesive tape has been joined to a surface of a semiconductor wafer (hereinafter, appropriately referred to as a “wafer”) and then has been cut in accordance with the following method. That is, the adhesive tape is supplied onto the surface of the wafer which is placed on and held by a chuck table. Next, a joining roller rolls on the adhesive tape to join the adhesive tape to the front face of the wafer. Next, a cutter blade travels along an outer periphery of the wafer while piercing through the adhesive tape. Alternatively, the cutter blade relatively travels along the outer periphery of the wafer in conjunction with rotation of the chuck table. In accordance with this method, a protective tape has been cut along an outer periphery of a wafer (refer to JP 2006-015453 A and JP 2004-025438 A).

Occasionally, when the cutter blade cuts the adhesive tape along the outer periphery of the wafer, an adhesive of the adhesive tape adheres to and is left on the cutter blade. Consequently, the cutter blade is degraded in cutting performance due to deposition of this adherent, leading to poor finishing of a section of the adhesive tape. In order to avoid this disadvantage, conventionally, the adherent has been manually wiped off from the cutter blade when the finishing of the section of the adhesive tape becomes poor. Alternatively, the adherent has been manually wiped off from the cutter blade at regular intervals. Then, a release agent has been applied to the cutter blade in order to reduce adhesion of the adhesive to the cutter blade.

However, the manual maintenance for the cutter blade requires time and effort, and inevitably interrupts the continuous process of joining the adhesive tape. Consequently, this manual maintenance causes deterioration of working efficiency.

### SUMMARY OF THE INVENTION

An object of this invention is to provide a cutter blade cleaning method and a cutter blade cleaning device each capable of accurately removing an adhesive from a cutter blade without manual operations, as well as an adhesive tape joining apparatus including the same.

In order to accomplish the object described above, this invention adopts the following configuration:

A cutter blade cleaning method for cleaning a cutter blade that cuts out an adhesive tape, which is joined to a surface of a substrate, along a contour of the substrate,

the cutter blade cleaning method including the steps of:

inserting a cutting edge of the cutter blade into a slit formed on a cleaning member from a lateral side of the slit and moving the cleaning member and the cutter blade relatively such that two side faces of the cutter blade come into contact with the slit;

moving the cleaning member and the cutter blade relatively in a direction which is different from a cutter blade inserting direction and pulling out the cutter blade from the slit at a position which is different from a position where the cutter blade starts to be inserted.

According to the cutter blade cleaning method of this invention, the cutter blade is inserted into the slit of the cleaning member, so that the cleaning member wipes off an adherent such as an adhesive on the faces of the cutter blade. Particularly, the position where the cutter blade starts to be inserted is different from the position where the cutter blade is pulled out. Therefore, the adherent, which is wiped off by the cleaning member once, never adheres again to the cutter blade. Accordingly, the cutter blade can cut the adhesive tape with good accuracy in the next tape cutting process.

In this method, preferably, the cleaning member has a notch which is tapered in a cutter blade traveling direction from the position where the cutter blade starts to be inserted.

According to this method, when the cutter blade starts to be inserted into the slit, the adherent is removed from the faces of the cutter blade and is pushed out in an opposite direction to the cutter blade traveling direction. That is, the adherent can be deposited and collected at the notch.

Accordingly, the adherent, which is wiped off and removed from the cutter blade once, never adheres again to the cutter blade which is pulled out from the position which is different from the position where the cutter blade starts to be inserted.

Also preferably, the cleaning member has a plurality of slits formed at a predetermined pitch so as to communicate with corresponding notches, and the cleaning member and the cutter blade are moved relatively in accordance with the pitch in order to clean the cutter blade.

As one example of such a form, the cleaning member is formed into a column shape, and the plurality of slits are formed along a circumference of the cleaning member at the predetermined pitch so as to communicate with the corresponding notches.

Also preferably, the cleaning member is impregnated with a wash liquid.

According to this method, the wash liquid softens or melts the adherent such as the adhesive adhering to the cutter blade, so that the cleaning member can wipe off the adherent promptly.

Preferably, the wash liquid has a releasing property for preventing an adherent from adhering to the cutter blade.

According to this method, after the adhesive is wiped off from the cutter blade, a release agent is applied to the clean cutting edge of the cutter blade. Thus, the cutter blade can be moved into the next tape cutting process with an adhesive hardly adhering

In this method, preferably, an adherent adhering to the cutter blade is monitored by a surveillance sensor.

According to this method, an amount of the adherent left on the cutter blade is checked by the monitoring performed immediately after execution of the cutter blade cleaning process. When the cleaning process is unsatisfactory, the cutter blade cleaning process may be executed again.

Accordingly, the next tape cutting process can be executed suitably with the clean cutter blade.

Moreover, when the cutter blade located at a standby position is monitored, determination can be made whether to execute the cutter blade cleaning process. Accordingly, in a case where no adherent adheres to the cutter blade or in a case where an adherent adheres to the cutter blade to such an extent that the cutter blade can cut the adhesive tape without problems, the cutter blade is not subjected to the cutter blade cleaning process. Thus, the favorable tape cutting process can be executed constantly while suppressing a frequency of the cutting blade cleaning process as much as possible.

In order to accomplish the object described above, this invention also adopts the following configuration:

A cutter blade cleaning device for cleaning a cutter blade that cuts out an adhesive tape, which is joined to a surface of a substrate, along a contour of the substrate,

wherein

the cutter blade is located so as to move vertically between an upper retracted position and a lower cutting operation position and a cleaning member is located so as to move horizontally between a cleaning position on a vertical movement path of the cutter blade and a receded position out of the vertical movement path; and

the cleaning member and the cutter blade are moved relatively such that the cutter blade moves horizontally in a tape cutting direction with respect to the cleaning member located at the cleaning position,

the cutter blade is inserted, from a cutting edge side thereof, into a slit formed on the cleaning member from a lateral side of the slit, is moved upward with two side faces thereof being brought into contact with the slit, and is pulled out upward from the slit.

With this configuration, the foregoing method invention can be implemented suitably.

In order to accomplish the object described above, this invention also adopts the following configuration:

An adhesive tape joining apparatus for joining an adhesive tape to a substrate, including:

a chuck table that holds a substrate placed thereon;

a tape supply device for supplying a surface-protective adhesive tape onto the substrate placed on and held by the chuck table, with an adhesion side of the adhesive tape being directed downward;

a joining roller that rolls on the adhesive tape while pressing the adhesive tape against the substrate to join the adhesive tape to a surface, which is directed upward, of the substrate;

a tape cutting device that allows a cutter blade, which moves vertically, to relatively travel along an outer periphery of the substrate in a state that the adhesive tape joined to the substrate is pierced with the cutter blade;

a separation roller that separates an unnecessary tape occurring from cutting of the tape and collects the unnecessary tape; and

a cutter blade cleaning device to clean the cutter blade in such a manner that the cutter blade, that moves vertically between an upper retracted position and a lower cutting operation position, is inserted into a cleaning member, wherein

the cleaning member and the cutter blade are moved relatively such that the cutter blade moves horizontally in a tape cutting direction with respect to the cleaning member located at the cleaning position, and

the cutter blade is inserted, from a cutting edge side thereof, into a slit formed on the cleaning member from a lateral side of the slit, is moved upward with two side faces thereof being brought into contact with the slit, and is pulled out upward from the slit.

With this configuration, the process of joining the adhesive tape to the substrate, the process of cutting the adhesive tape along the outer periphery of the substrate, and the process of collecting the unnecessary tape can be efficiently executed in succession. Further, the process of cleaning the cutter blade can be executed without burdensome manual operation, and the adhesive tape can be cut constantly with the clean cutting edge of the cutter blade. Thus, there can be performed joining of the cut adhesive tape having a smooth section thereof with no irregularity.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view showing a general configuration of a protective tape joining apparatus;

FIG. 2 is a side view showing a general configuration of a tape cutting device;

FIG. 3 is a perspective view showing main components of the tape cutting device;

FIG. 4 is a plan view showing a cutter unit;

FIG. 5 is a longitudinal sectional front view showing a portion of the cutter unit;

FIG. 6 is a side view showing main components of the cutter unit when an adhesive tape is pierced with a cutter blade;

FIG. 7 is a side view showing the main components of the cutter unit in a state that the cutter blade is brought into contact with an outer peripheral edge of a wafer;

FIGS. 8 to 11 are front views each showing an adhesive tape joining process;

FIG. 12 is a side view showing a cutter blade cleaning device;

FIG. 13 is a plan view showing the cutter blade cleaning device;

FIG. 14 is a longitudinal sectional side view showing a cleaning unit in a cleaning position;

FIG. 15 is a plan view showing the cleaning unit;

FIG. 16 is a perspective view showing a cleaning member; and

FIG. 17 is a perspective view showing another cleaning member.

### DESCRIPTION OF THE PREFERRED EMBODIMENTS

With reference to the drawings, hereinafter, description will be given of preferred embodiments of this invention.

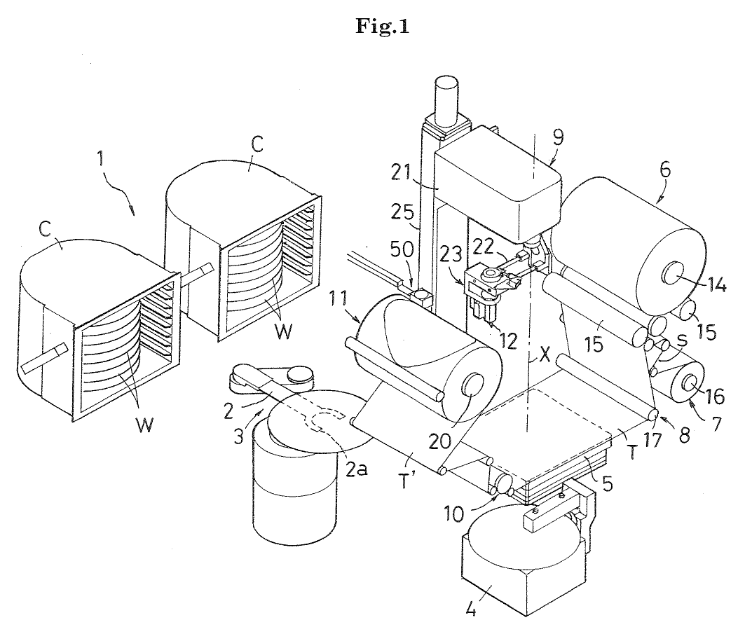

FIG. 1 is a perspective view showing a general configuration of a protective tape joining apparatus as one example of an adhesive tape joining apparatus.

This protective tape (adhesive tape) joining apparatus includes: a wafer supply/collection part 1 with a cassette C mounted therein for housing a semiconductor wafer (hereinafter, simply referred to as a “wafer”) W as one example of a substrate; a wafer transport mechanism 3 that has a robot arm 2; an alignment stage 4; a chuck table 5 that suction-holds the wafer W placed thereon; a tape supply part 6 that supplies a surface-protective adhesive tape T provided with a separator s onto a position above the wafer W; a separator collection part 7 that separates the separator s from the adhesive tape T supplied from the tape supply part 6 and collects the separator s; a joining unit 8 that joins the adhesive tape T to the wafer W placed on and suction-held by the chuck table 5; a tape cutting device 9 that cuts out the adhesive tape T joined to the wafer W along a contour of the wafer W; a separation unit 10 that separates an unnecessary tape T′, which is a portion of the cut adhesive tape T joined to the wafer W, from the adhesive tape T; a tape collection part 11 that winds and collects the unnecessary tape T′ separated by the separation unit 10; and others. Hereinafter, description will be given of detailed configurations of the respective structural parts and mechanisms.

The wafer supply/collection part 1 is configured with two cassettes C arranged in parallel. A plurality of wafers W are inserted into and housed in each cassette C in a stack manner. Herein, each wafer W is housed in a horizontal position with a wiring pattern face (a surface) thereof being directed upward.

The robot arm 2 of the wafer transport mechanism 3 can move forward and backward horizontally. Moreover, the entire robot arm 2 is driven to turn and move vertically. A wafer holding part 2a is provided at a tip end of the robot arm 2. The wafer holding part 2a is formed into a horseshoe shape and is of a vacuum-suction type. That is, the wafer holding part 2a is inserted between the stacked wafers W housed in the cassette C, and suction-holds the wafer W from a back face of the wafer W. The robot arm 2 pulls out the suction-held wafer W from the cassette C, and transports the wafer W to the alignment stage 4, the chuck table 5 and the wafer supply/collection part 1 in turn.

When the wafer transport mechanism 3 transports the wafer W to the alignment stage 4 and places the wafer W on the alignment stage 4, the alignment stage 4 performs alignment on the wafer W, based on a notch or an orientation flat formed at an outer periphery of the wafer W.

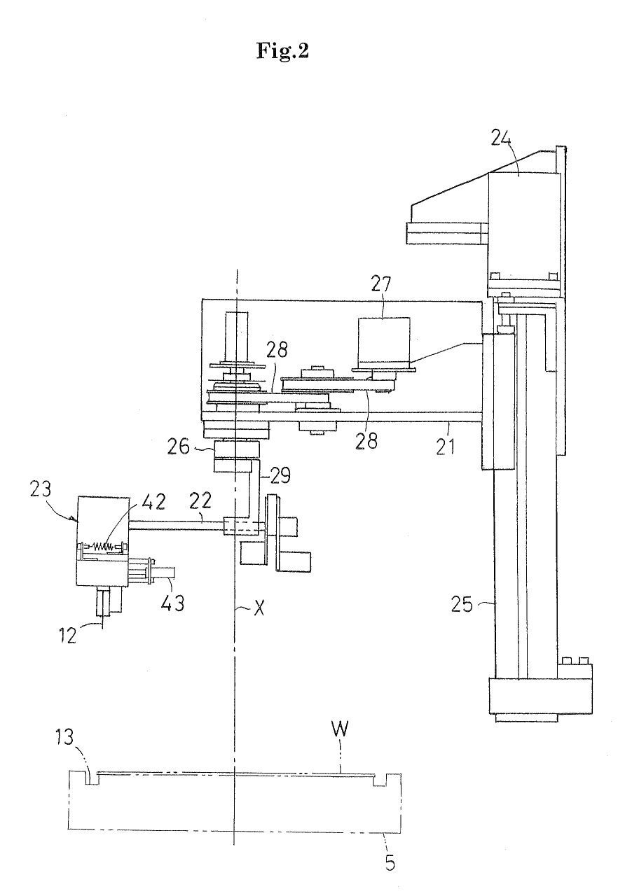

When the wafer transport mechanism 3 transfers the wafer W from the alignment stage 4 to the chuck table 5 and places the wafer W on the chuck table 5 in a predetermined alignment attitude, the chuck table 5 sucks the wafer W by vacuum. As shown in FIG. 2, moreover, a cutter traveling groove 13 is formed on a top face of the chuck table 5. The cutter traveling groove 13 allows a cutter blade 12 of the adhesive tape cutting device 9 (to be described later) to travel along the contour of the wafer W and to cut the adhesive tape T.

The tape supply part 6 has the following configuration. That is, the adhesive tape T provided with the separator s is fed out from a supply bobbin 14, and then is guided to and wound around a group of guide rollers 15. When being separated from the separator s, the adhesive tape T is guided to the joining unit 8. Herein, the supply bobbin 14 is applied with appropriate resistance against its rotation in order to prevent the adhesive tape T from being fed out excessively.

The separator collection part 7 has the following configuration. That is, a collection bobbin 16 is driven to rotate in a winding direction in order to wind the separator s separated from the adhesive tape T.

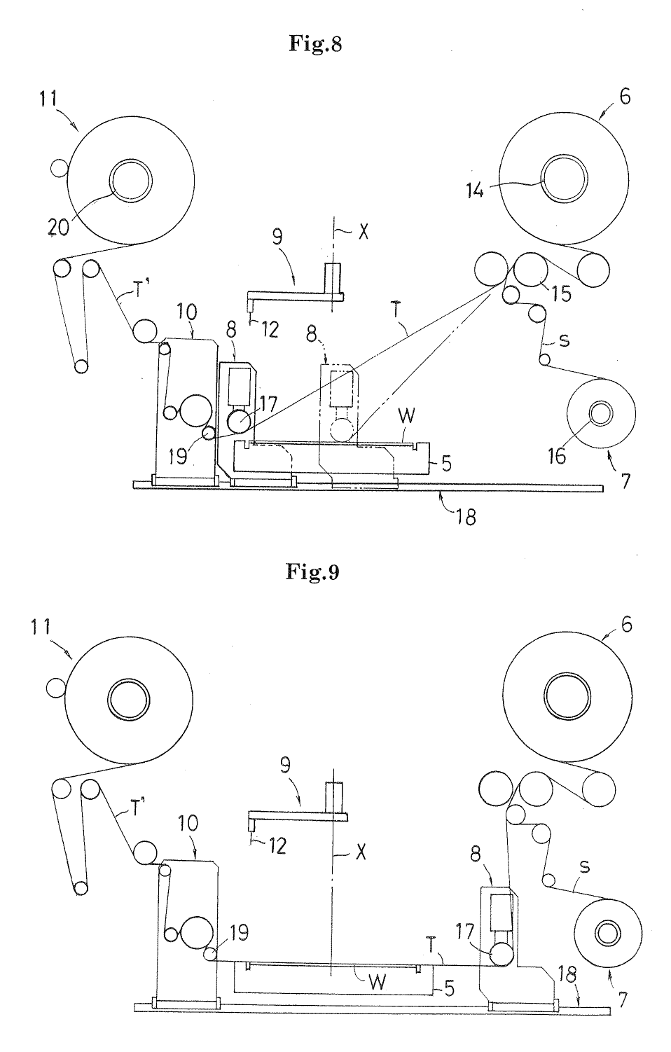

As shown in FIG. 8, a joining roller 17 is provided horizontally on the joining unit 8 so as to be oriented forward. The joining roller 17 is driven by a slide guide mechanism 18 and a screw-feed type drive mechanism (not shown) to reciprocate horizontally.

Moreover, a separation roller 19 is provided horizontally on the separation unit 10 so as to be oriented forward. The separation roller 19 is also driven by the slide guide mechanism 18 and the screw-feed type drive mechanism (not shown) to reciprocate horizontally.

In the tape collection part 11, a collection bobbin 20 rotates in a winding direction in order to wind the unnecessary tape T′.

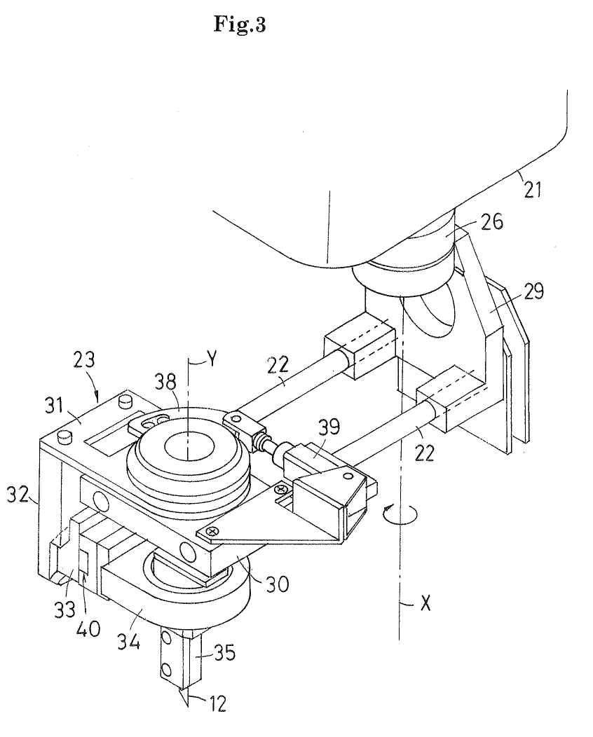

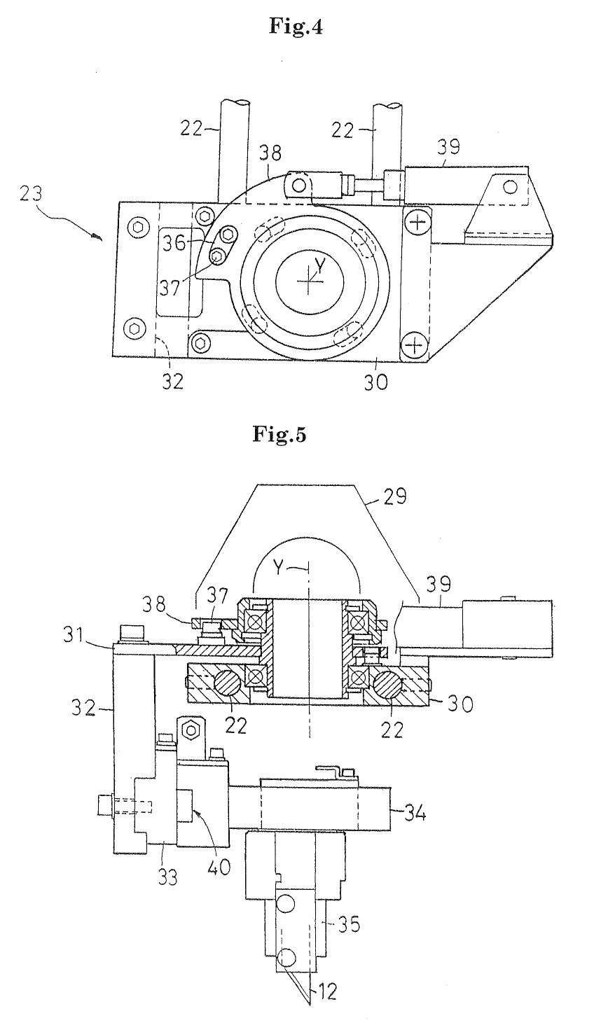

As shown in FIGS. 2 and 3, the tape cutting device 9 has the following configuration. That is, a pair of support arms 22 are arranged in parallel at a lower side of a vertically moving table 21 capable of moving vertically. The pair of support arms 22 can turn about a vertical axis X positioned at a center of the chuck table 5. A cutter unit 23 is provided at a free end of the support arm 22, and the cutter blade 12 is attached to the cutter unit 23 with a nose thereof being directed downward. More specifically, when the support arm 22 turns about the vertical axis X, the cutter blade 12 travels along the outer periphery of the wafer W to cut out the adhesive tape T. FIGS. 2 to 7 show a structure of the tape cutting device 9 in detail.

The vertically moving table 21 moves vertically along an upright frame 25 in a screw-feed manner when a motor 24 rotates forward/backward. A rotation shaft 26 is attached to a free end of the vertically moving table 21 so as to rotate about the vertical axis X and a motor 27 is provided on the vertically moving table 21. The rotation shaft 26 is interlocked with the motor 27 through two belts 28 such that a rotation speed thereof is reduced. In other words, when the motor 27 is actuated, the rotation shaft 26 rotates in a predetermined direction. Further, a support member 29 extends downward from the rotation shaft 26, and the support arm 22 is supported at a lower end of the support member 29 so as to pass through the support member 29. Herein, the support arm 22 can slide horizontally. Accordingly, when the support arm 22 slides horizontally, a length from the vertical axis X to the cutter blade 12 can be changed. In other words, a turning radius of the cutter blade 12 can be adjusted and changed in accordance with a diameter of a wafer.

As shown in FIGS. 3 to 5, a bracket 30 is fixedly attached to the free end of the support arm 22. The cutter unit 23 is attached to and supported with the bracket 30. The cutter unit 23 includes a turning member 31 supported with the bracket 30 so as to turn about a vertical axis Y within a predetermined range, an upright wall-shaped support bracket 32 coupled to a bottom face of an end of the turning member 31, a cutter support member 33 coupled to a side face of the support bracket 32, a bracket 34 supported by the cutter support member 33, a cutter holder 35 attached to the bracket 34, and the like. Herein, the cutter blade 12 is fastened to and fixed on a side face of the cutter holder 35 so as to be exchangeable with new one.

Herein, an operation flange 38 is provided above the turning member 31 and turns together with the turning member 31 by engagement of an oval hole 36 with a protrusion 37. The operation flange 38 turns by means of an air cylinder 39, so that the attitude of the entire cutter unit 23 is changed about the vertical axis Y, with respect to the support arm 22. That is, the actuation of the air cylinder 39 allows adjustment of an angle (a cutting angle) of the cutter blade 12 with respect to the moving direction within a predetermined range.

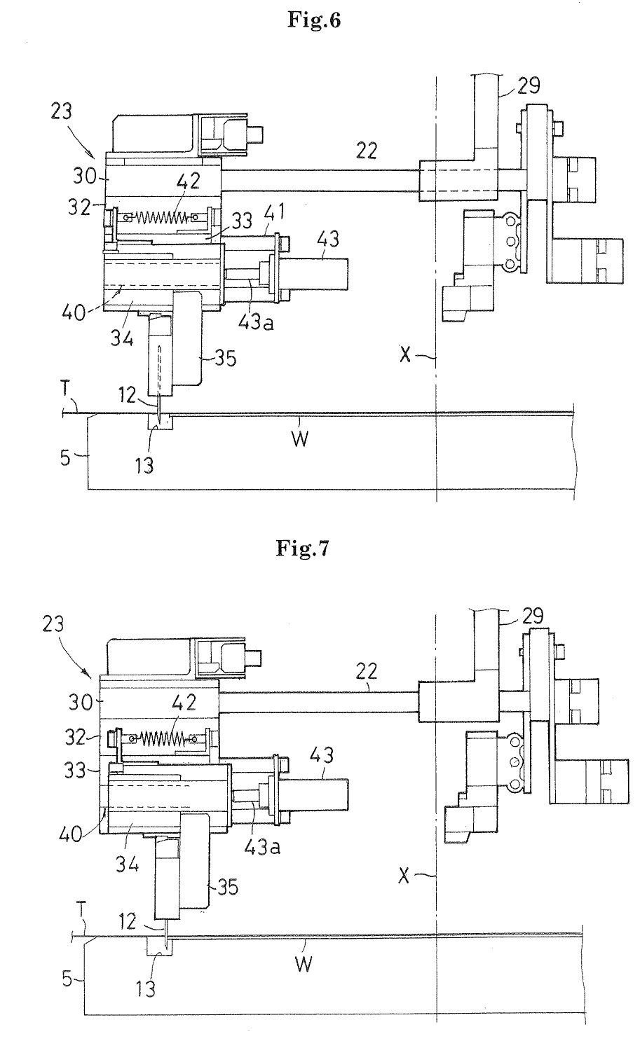

The bracket 34 is supported by the cutter support member 33 so as to slide linearly in a longitudinal direction (a front/back direction of a plane of FIG. 5) of the support arm 22 through a guide rail mechanism 40. A spring 42 is provided between the cutter support member 33 and the bracket 34 with tension being applied thereto. As shown in FIGS. 6 and 7, an elastic restoring force of the spring 42 allows the bracket 34 to slide in a direction so as to approach the vertical axis (the turning center) X.

An air cylinder 43 is fixedly provided at a turning center of the cutter support member 33 through a stator 41 along the sliding direction of the bracket 34. The air cylinder 43 has a piston rod 43a provided so as to come into contact with an end face of the bracket 34.

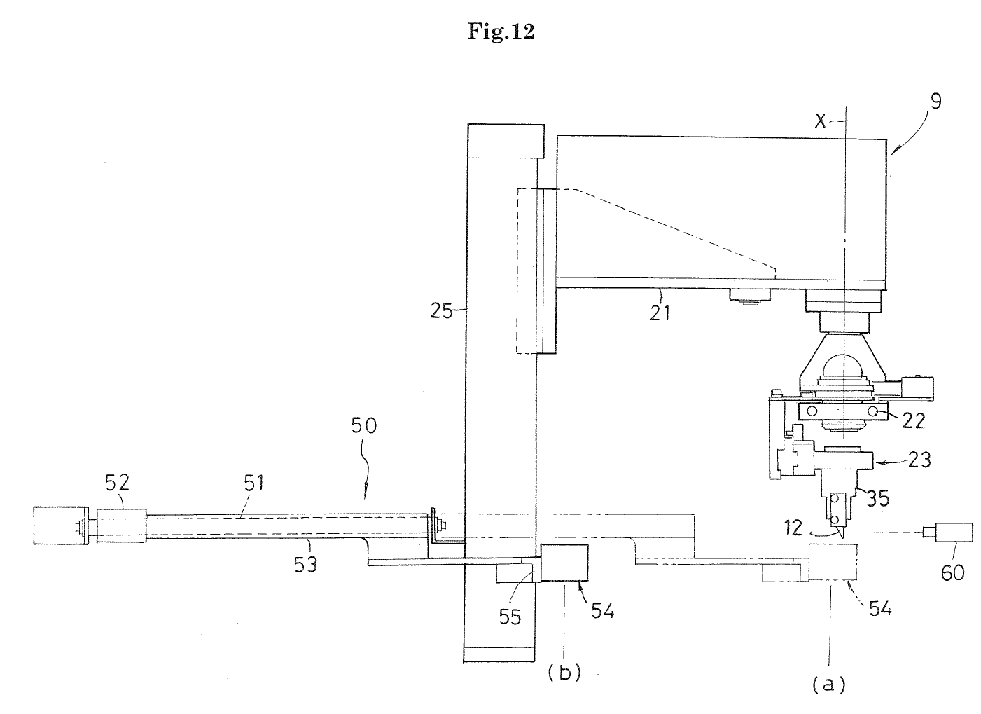

As shown in FIGS. 12 to 14, the tape cutting device 9 includes a cutter blade cleaning device 50 that removes an adhesive and the like from the cutter blade 12.

The cutter blade cleaning device 50 includes a rodless cylinder 51, a movable table 52, a support arm 53, a cleaning unit 54 and the like. Herein, the rodless cylinder 51 is provided horizontally at a lower back side of the upright frame 25 so as to be oriented in an opposite direction (hereinafter, referred to as a “backward direction”) to a direction (hereinafter, referred to as a “forward direction”) that the vertically moving table 21 protrudes. The movable table 52 is driven by the rodless cylinder 51 so as to reciprocate longitudinally. The support arm 53 is coupled to and supported by the movable table 52 and extends forward in a horizontal cantilever manner. The cleaning unit 54 is provided at a tip end of the support arm 53.

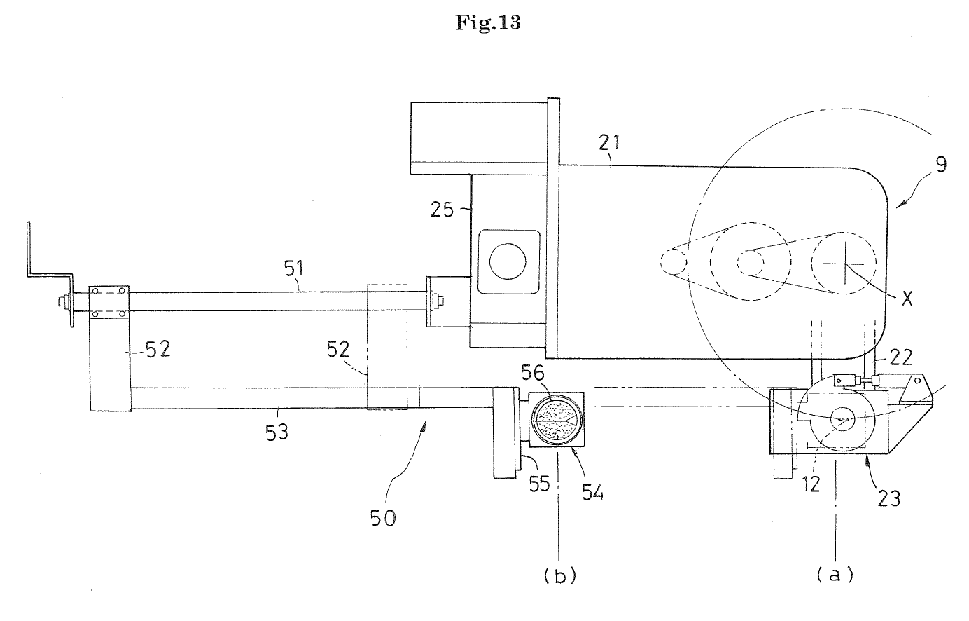

As shown in FIGS. 13 to 15, the cleaning unit 54 has the following configuration. That is, a container 57 that houses a cleaning member 56 is attached to a support bracket 55 coupled to and provided at a front end of the support arm 53. The cleaning member 56 is a porous member such as a sponge. Moreover, the cleaning member 56 is kept at a moderate wet state in such a manner that the cleaning member 56 absorbs a wash liquid in the container 57 by a capillary phenomenon. The wash liquid is prepared as follows. That is, a release agent (e.g., a surfactant, a silicone-containing liquid) for preventing an adhesive from adhering to the cutter blade 12 is mixed into a solvent for softening or melting the adhesive adhering to the cutter blade 12.

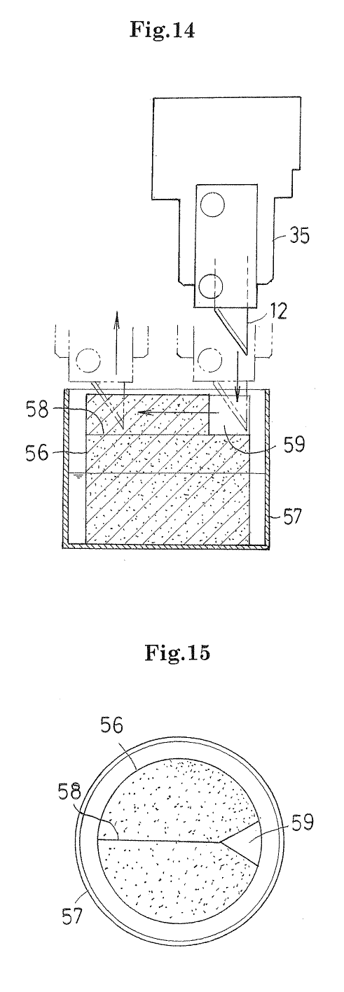

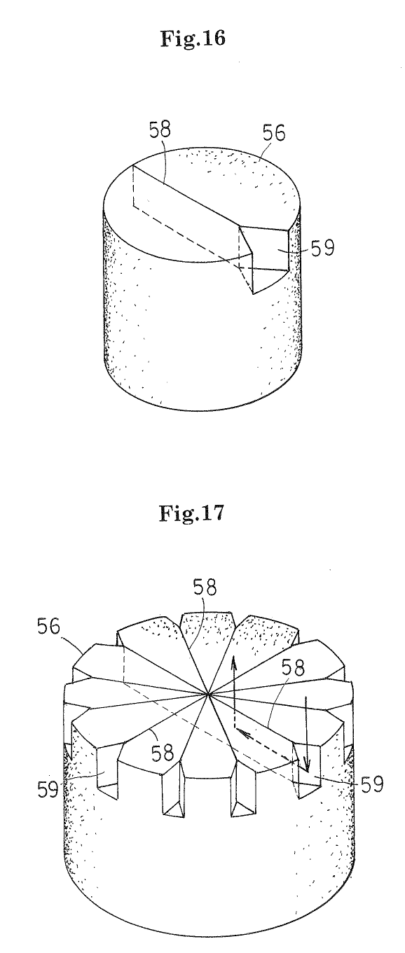

As shown in FIGS. 14 to 16, the cleaning member 56 is formed into a column shape. Moreover, a slit 58 having a predetermined depth is formed on a top face of the cleaning member 56 in a diameter direction. Further, a “V”-shaped opening 59 is formed at one end of the slit 58. In other words, a notch is formed on the cleaning member 56 so as to be tapered toward a direction that the cutter blade 12 inserted into the slit 58 moves horizontally. Herein, the depth of the slit 58 is larger than a length of the cutter blade 12 to be inserted into the slit 58. Moreover, the slit 58 formed on the cleaning member 56 in the diameter direction has a length longer than a length from a cutting edge of the cutter blade 12 to a rear end edge of the cutter blade 12.

As shown in FIG. 13, when the movable table 52 moves forward to a terminal, the cleaning unit 54 is located at a cleaning position (a) on a vertical movement path of the cutter blade 12 located at an upper retracted position. Moreover, when the movable table 52 moves backward, the cleaning unit 54 is located at a retreat position (b) out of the movable movement path of the cutter blade 12 in the rearward direction. That is, when a longitudinal movement stroke of the movable table 52 is set, the position of the cleaning unit 54 is changed.

Moreover, a surveillance sensor 60 such as a CCD camera is installed so as to face the cutter blade 12 located at the upper position. The CCD camera monitors presence or absence of the adherent on the cutter blade 12.

With reference to FIGS. 8 to 11, next, description will be given of a series of operations for joining the adhesive tape T to the surface of the wafer W and then cutting the adhesive tape T with the adhesive tape joining apparatus according to this invention.

Upon reception of a command to join the adhesive tape T, first, the robot arm 2 of the wafer transport mechanism 3 moves toward the cassette C mounted on a cassette table, and the wafer holding part 2a is inserted between the wafers W housed in the cassette C. The wafer holding part 2a suction-holds the wafer W from below (i.e., from the back face of the wafer W), pulls out the wafer W from the cassette C, and moves to mount the wafer W to the alignment stage 4.

The alignment stage 4 performs the alignment on the wafer W placed thereon, through use of the notch formed at the outer periphery of the wafer W. Thereafter, the robot arm 2 transfers the wafer W subjected to the alignment from the alignment stage 4 to the chuck table 5, and places the wafer W on the chuck table 5.

The chuck table 5 suction-holds the wafer W placed thereon in the state that the center of the wafer W is located at the center of the chuck table 5. As shown in FIG. 8, herein, the joining unit 8 and the separation unit 10 are in initial positions on the left side, respectively. Moreover, the cutter blade 12 of the tape cutting device 9 is in an initial position on the upper side.

As shown by an imaginary line in FIG. 8, next, the joining roller 17 of the joining unit 8 moves downward. Then, the joining roller 17 rolls on the wafer W in the forward direction (the right direction in FIG. 8) while pressing the adhesive tape T downward against the wafer W. Thus, the adhesive tape T is joined to the surface of the wafer W and the top face of the chuck table 5.

As shown in FIG. 9, when the joining unit 8 arrives at a terminal position, the cutter blade 12 moves downward, so that the adhesive tape T on the cutter traveling groove 13 of the chuck table 5 is pierced with the cutter blade 12.

As shown in FIG. 6, in this case, high-pressure air is supplied into the air cylinder 43, so that the piston rod 43a protrudes largely. Accordingly, the bracket 34 slides to an outward stroke end against the spring 42. Herein, the adhesive tape T is pierced with the cutter blade 12 at a position where the cutter blade 12 is slightly spaced away from an outer peripheral edge of the wafer W. (by several millimeters). Thereafter, the air pressure in the air cylinder 43 is reduced such that the protruding force of the piston rod 43a becomes smaller than the biasing force of the spring 42. As shown in FIG. 7, then, the bracket 34 slides in such a manner that the spring 42 presses and biases the bracket 34. Thus, the nose of the cutter blade 12 is pressed against the outer peripheral edge of the wafer W at an appropriate contact pressure.

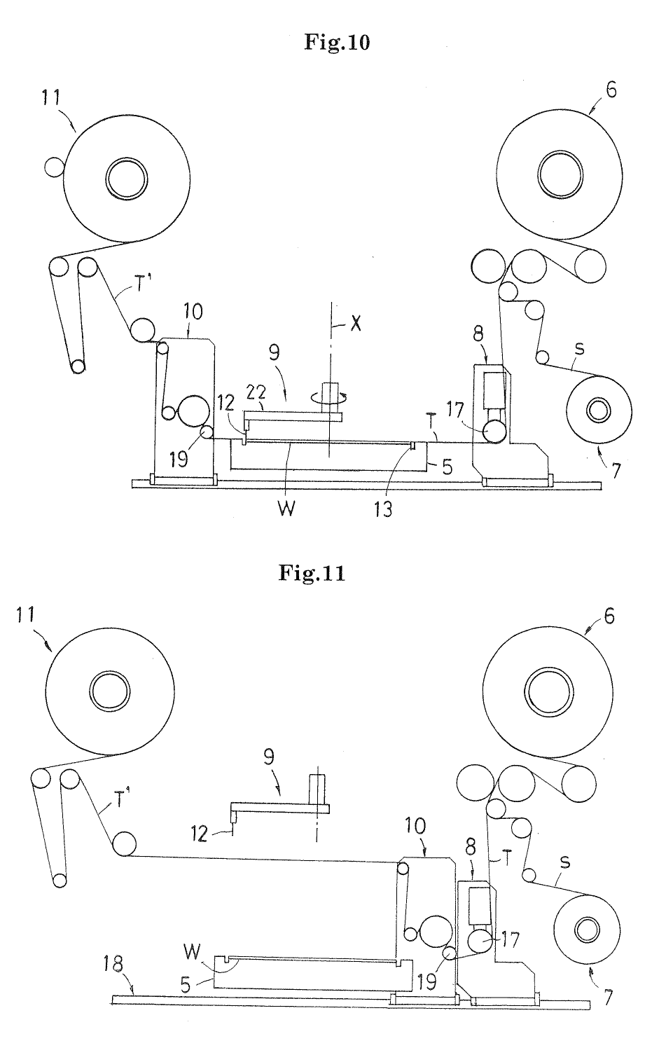

When the operation of pressing the cutter blade 12 against the outer peripheral edge of the wafer W is completed at a cutting start position, the support arm 22 turns as shown in FIG. 10. This turn allows the cutter blade 12 to turn while coming sliding into contact with the outer peripheral edge of the wafer W, so that the adhesive tape T is cut along the outer periphery of the wafer W.

When the operation of cutting the adhesive tape T along the outer periphery of the wafer W is completed, the cutter blade 12 moves upward and returns to the original standby position as shown in FIG. 11. Next, the separation unit 10 moves forward to separate the remained unnecessary tape T′ after cut out on the wafer W while lifting up the unnecessary tape T′.

When the separation unit 10 arrives at a separation completion position, the separation unit 10 and the joining unit 8 recede and return to the initial positions, respectively. Herein, the collection bobbin 20 winds the unnecessary tape T′ and the tape supply part 6 feeds out the adhesive tape T in a given amount.

When the forgoing tape joining operation is completed, the chuck table 5 releases the suction-holding of the wafer W. Then, the wafer holding part 2a of the robot arm 2 moves to mount the wafer W subjected to the tape joining processing from the chuck table 5 to the wafer supply/collection part 1, and inserts the wafer W into the cassette C.

Thus, the series of operations, that is, a tape joining process is completed. Thereafter, the foregoing operations are performed on each new wafer in succession.

Each time the tape joining process is completed, the surveillance sensor 60 shown in FIG. 12 monitors an amount of an adhesive on the cutter blade 12. For example, an optical system camera is used as the surveillance sensor 60 to obtain a degree of attachment of an adhesive, based on image processing. Alternatively, the surveillance sensor 60 emits light such as a laser beam to the cutter blade 12 and measures such a degree of attachment, based on intensity of light reflected from the cutter blade 12. As a result of the monitoring, when the amount of the adhesive adhering to the cutter blade 12 is determined to be not less than a predetermined setting value, a cutter blade cleaning process is executed as follows.

When the cutter blade 12 returns to the upper retracted position, the rodless cylinder 51 of the cutter blade cleaning device 50 is actuated. Then, the cleaning unit 54 moves forward from the receded position (b) toward the cleaning position (a).

When the cleaning unit 54 arrives at the cleaning position (a), first, the cutter blade 12 in the upper retracted position enters the opening 59 of the cleaning member 56 and moves downward to a predetermined height.

Next, the cutter blade 12 turns by a predetermined amount in a tape cutting direction (such that the rear end edge of the cutter blade 12 reaches into the slit 58). Thus, the cutting edge of the cutter blade 12 is inserted into the slit 58 of the cleaning member 56 almost horizontally from the opening side of the slit 58. Herein, the cutter blade 12 moves along the slit 58 in a state that two side faces thereof come into contact with two inner side faces of the slit 58. Thus, the adherent such as the adhesive on the cutter blade 12 is wiped off by the cleaning member 56 while being softened or melted by the wash liquid with which the cleaning member 56 is impregnated.

The cutter blade 12 turns by the predetermined amount and then moves upward, so that the adherent on the cutter blade 12 is finally wiped off in the nose direction of the cutter blade.

After completion of the cutter blade cleaning process, the adherent left on the cutter blade 12 is monitored by the surveillance sensor 60. Herein, if the amount of the adherent left is large, the cutter blade cleaning process is executed again.

When the cutter blade 12 returns to the upper retracted position, the cleaning unit 54 moves backward from the cleaning position (a) toward the receded position (b) to be prepared the next cutter blade cleaning process.

Herein, it is preferable that a water-soluble oil agent is used as the wash liquid in the case of cutting the surface-protective adhesive tape T joined to the wafer W. Specifically, the wafer W, to which the surface-protective adhesive tape T is joined, is washed with water in a back-grinding step. For this reason, even when the wash liquid applied to the cutter blade 12 adheres to and is left on the section of the cut adhesive tape T, the water removes the wash liquid from the section of the cut adhesive tape T together with abrasive powder in the back-grinding step. Accordingly, this configuration prevents such a disadvantage that the wash liquid, which adheres to and is left on the section of the cut adhesive tape T, exerts an adverse influence in subsequent processing steps.

The support bracket 55 that supports the cleaning unit 54 is attached to the movable arm 53 such that the position thereof can be changed in a direction orthogonal to the moving direction of the movable board 52. That is, when a distance between the cutter unit 23 and the vertical axis X is changed in accordance with change in size of a wafer W to be used, the attachment position of the support bracket 55 is changed in accordance with this change in distance such that the cleaning member 56 is on or out of the vertical movement path of the cutter blade 12.

According to the adhesive tape joining apparatus including the cutter blade cleaning device 50 described above, the cutting edge of the cutter blade 12 is inserted into the slit 58 of the cleaning member 56 from the opening 59 and moves horizontally. Therefore, the adherent adhering on the two side faces of the cutter blade 12 is scrubbed at the opening end of the slit 58 and is deposited and collected at the opening 59.

Moreover, since the two side faces of the cutter blade 12 come into contact with the two inner side walls of the slit 58, the adherent is melted by the wash liquid contained in the cleaning member 56 and is wiped off by the cleaning member 56. Further, the cutter blade 12 is moved horizontally by the predetermined amount and then is pulled out upward from the slit 58, that is, the position where the cutter blade 12 is pulled out is different from the position where the cutter blade 12 starts to be inserted. Therefore, the adherent on the nose of the cutter blade 12 is wiped off by the cleaning member 56 at the time when the cutter blade 12 is pulled out upward.

Accordingly, the adherent is removed from the cuter blade 12 in the two direction, that is, the horizontal direction and the vertical direction. This configuration improves accuracy of removing the adherent. Moreover, the adherent removed from the cutter blade 12 is almost disposed and collected at the opening 59. This configuration prevents the adherent from adhering to the cutter blade 12 again.

In addition to the foregoing embodiment, this invention may be embodied variously as follows.

(1) In this embodiment, the cutter blade cleaning process may be executed regularly each time the tape cutting process is executed by a predetermined frequency.

(2) As shown in FIG. 17, a plurality of slits 58 may be formed on the cleaning member 56 at a predetermined angle pitch in a circumferential direction. In this case, when the cutter blade cleaning process using a certain slit 58 is completed, the cleaning member 56 rotates by one pitch in the circumferential direction. Thus, the next cutter blade cleaning process can be executed by use of a different slit 58. This configuration allows a long-term use of one cleaning member 56 in an effective manner.

(3) Alternatively, an optical sensor may monitor a liquid surface level of the wash liquid in the container 57 and a computing unit may compare the measured liquid surface level with a predetermined reference level. Then, when a result of the comparison falls below a preset range, an alarm may be given to the user in order to refill the wash liquid. With this configuration, the slit 58 can be kept at a state that the slit 58 is wet moderately by the wash liquid without fail, leading to improvement in performance of removing an adherent from the cutter blade 12.

(4) In the foregoing embodiment, the cleaning member 56 is a porous member such as a sponge. Alternatively, various materials may be used as the cleaning member 56, such as a brush, felt, paper material, and fabric material, that can be impregnated with the wash liquid.

(5) Alternatively, the cutter blade 12 moves downward so as to enter the opening 59, and then the cleaning member 56 moves forward in the horizontal direction. Thus, the cutter blade 12 may be relatively inserted into the slit 58 of the cleaning member 56 from the lateral side of the slit 58.

(6) Alternatively, a lid may be fitted to the container 57. Herein, such a lid has an opening 59 which extends along a path that the cutter blade 12 is inserted in a direction that the cutter blade 12 travels horizontally. With this configuration, the wash liquid can be prevented from evaporating in the air.

In this configuration, moreover, a rubber member or a brush member may be provided at a position where the cutter blade 12 is pulled out. With this configuration, the adherent and the excessive wash liquid can be removed from the cutter blade 12 at the time when the cutter blade 12 is pulled out from the slit 58.

(7) Alternatively, heat may be applied to the cleaning member 56 housed in the container 57. With this configuration, the temperature of the cutter blade 12 can be kept at an almost fixed level. Therefore, the cutter blade 12 can efficiently cut an adhesive tape which can not be cut with ease when the temperature varies.

This invention may be embodied in other specific forms without departing from the spirit or essential attributes thereof and, accordingly, reference should be made to the appended claims, rather than to the foregoing specification, as indicating the scope of the invention.

What is claimed is:

1. A cutter blade cleaning method for cleaning a cutter blade that cuts out an adhesive tape, which is joined to a surface of a substrate, along a contour of the substrate,
the cutter blade cleaning method comprising the steps of:
inserting a cutting edge of the cutter blade into a slit formed on a cleaning member from a lateral side of the slit and moving the cleaning member and the cutter blade relatively such that two side faces of the cutter blade come into contact with the slit; and
moving the cleaning member and the cutter blade relatively in a direction which is different from a cutter blade inserting direction and pulling out the cutter blade from the slit at a position which is different from a position where the cutter blade starts to be inserted.

2. The cutter blade cleaning method according to claim 1, wherein
the cleaning member has a notch which is tapered in a cutter blade traveling direction from the position where the cutter blade starts to be inserted.

3. The cutter blade cleaning method according to claim 2, wherein
the cleaning member has a plurality of slits formed at a predetermined pitch so as to communicate with corresponding notches, and the cleaning member and the cutter blade are moved relatively in accordance with the pitch in order to clean the cutter blade.

4. The cutter blade cleaning method according to claim 3, wherein
the cleaning member is formed into a column shape, and the plurality of slits are formed along a circumference of the cleaning member at the predetermined pitch so as to communicate with the corresponding notches.

5. The cutter blade cleaning method according to claim 1, wherein
the cleaning member is impregnated with a wash liquid.

6. The cutter blade cleaning method according to claim 5, wherein
the wash liquid has a releasing property for preventing an adherent from adhering to the cutter blade.

7. The cutter blade cleaning method according to claim 1, wherein
an adherent adhering to the cutter blade is monitored by a surveillance sensor.

8. A cutter blade cleaning device for cleaning a cutter blade that cuts out an adhesive tape, which is joined to a surface of a substrate, along a contour of the substrate,
the cutter blade cleaning device comprising:
a cutter blade that moves vertically between an upper retracted position and a lower cutting operation position; and
a cleaning member that moves horizontally between a cleaning position on a vertical movement path of the cutter blade and a receded position out of the vertical movement path, wherein
the cleaning member and the cutter blade are moved relatively such that the cutter blade moves horizontally in a tape cutting direction with respect to the cleaning member located at the cleaning position, and
the cutter blade is inserted, from a cutting edge side thereof, into a slit formed on the cleaning member from a lateral side of the slit, is moved upward with two side faces thereof being brought into contact with the slit, and is pulled out upward from the slit.

9. The cutter blade cleaning device according to claim 8, wherein
the cleaning member has a notch which is tapered in a cutter blade traveling direction from the position where the cutter blade starts to be inserted.

10. The cutter blade cleaning device according to claim 9, wherein
the cleaning member has a plurality of slits formed at a predetermined pitch so as to communicate with corresponding notches; and
a rotation drive mechanism allows the cleaning member and the cutter blade to rotate and move relatively in accordance with the pitch.

11. An adhesive tape joining apparatus for joining an adhesive tape to a substrate, comprising:
a chuck table that holds a substrate placed thereon;
a tape supply device for supplying a surface-protective adhesive tape onto the substrate placed on and held by the chuck table, with an adhesion side of the adhesive tape being directed downward;
a joining roller that rolls on the adhesive tape while pressing the adhesive tape against the substrate to join the adhesive tape to a surface, which is directed upward, of the substrate;
a tape cutting device that allows a cutter blade, which moves vertically, to relatively travel along an outer periphery of the substrate in a state that the adhesive tape joined to the substrate is pierced with the cutter blade;
a separation roller that separates an unnecessary tape occurring from cutting of the tape and collects the unnecessary tape; and
a cutter blade cleaning device to clean the cutter blade in such a manner that the cutter blade, that moves vertically between an upper retracted position and a lower cutting operation position, is inserted into a cleaning member, wherein
the cleaning member and the cutter blade are moved relatively such that the cutter blade moves horizontally in a tape cutting direction with respect to the cleaning member located at the cleaning position, and
the cutter blade is inserted, from a cutting edge side thereof, into a slit formed on the cleaning member from a lateral side of the slit, is moved upward with two side faces thereof being brought into contact with the slit, and is pulled out upward from the slit.

12. The adhesive tape joining apparatus according to claim 11, wherein
the cleaning member has a notch which is tapered from the position where the cutter blade is inserted toward a cutter blade traveling direction.

13. The adhesive tape joining apparatus according to claim 12, wherein
the cleaning member has a plurality of slits formed at a predetermined pitch so as to communicate with corresponding notches; and
a rotation drive mechanism allows the cleaning member and the cutter blade to rotate and move relatively in accordance with the pitch.
